(19) United States
(12) Patent Application Publication
(10) Pub. No.: US 2026/0371116 A1
(43) Pub. Date: Nov. 19, 2026

(54) Network Node and Method in a Wireless Communications Network

(71) Applicant: Telefonaktiebolaget LM Ericsson (publ), Stockholm (SE)

(72) Inventors: Martin Hessler, Linköping (SE); Johan Kåredal, Lund (SE); Niclas Wiberg, Linköping (SE)

(21) Appl. No.: 19/126,389

(22) PCT Filed: Dec. 19, 2022
(86) PCT No.: PCT/EP2022/086654

§ 371 Date: May 1, 2025

(51) Int. Cl. H04W 24/06; H04B 17/345; H04B 17/391

(52) U.S. Cl. CPC H04W 24/06; H04B 17/345; H04B 17/3912

(57) ABSTRACT

A method performed by a network node is provided. The method is for emulating a radio channel between a base station and a User Equipment, UE, in a wireless communications network. The network node models (202) the radio channel as a set of channel taps. Each channel tap out of the set of channel taps is defined by a gain and a delay. The network node computes (203) a frequency response of the radio channel directly from the set of channel taps. The frequency response is computed for a set of frequencies used by a transmitted signal in the radio channel based on the gain and the delay of the set of channel taps. The network node then emulates the radio channel by applying (204) the computed frequency response to the transmitted signal. This is performed by multiplying the computed frequency response with a frequency domain representation of the signal transmitted on the set of a frequencies.

### TECHNICAL FIELD

Embodiments herein relate to a network node and a method therein. In some aspects, they relate to emulating a radio channel between a base station and a User Equipment (UE) in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

Radio channel emulation and simulation are important for supporting systems and technologies for radio communication. They aim to mimic some aspects of real radio environments, and vary in their complexity, flexibility, and realism.

Radio channel simulation is often used when studying signal waveforms and signal processing algorithms. Simulators are typically implemented in software on standard compute platforms, and generally run slower than the target systems they are aimed for.

Radio channel emulation is similar but is often connected to real communication systems for testing and verification. Emulators are typically running in real-time speed and use dedicated hardware. They are often relatively expensive compared to standard compute platforms.

A new and promising application is digital twins. In general a digital twin is a virtual representation of a real-world physical system or product, a physical twin, that serves as the indistinguishable digital counterpart of it for practical purposes, such as system simulation, integration, testing, monitoring, and maintenance.

The new and promising application digital twins comprises modern software and hardware technologies making it possible to deploy almost entire radio communication systems as software on standard compute platforms. The exception is the radio-frequency parts, including radio transmitters and receivers, antennas, and the radio propagation environment itself. This creates a desire to employ radio channel emulation as software on standard compute platforms, to enable full digital twins for radio communication systems.

In most cases, several transmitters and receivers are active simultaneously, and a radio channel emulator may need to model many radio channels simultaneously. A received signal is then typically computed as the sum of the received signals from multiple transmitters, considering all the relevant radio channels for that receiver.

Some channel models are defined as part of communication standards, for example by organizations such as 3GPP, and used for formal verification of communication equipment as part of a certification process. Such models are often stochastic in nature and might define random characteristics for the radio channel parameters.

For a digital twin it may be desired to instead model specific scenarios, for example based on virtual 3D environments with objects such as buildings that may affect the radio channel in various ways. This enables a higher degree of realism and study of particularly interesting scenarios, for example dynamic scenarios with moving user terminals and where obstacles appear dynamically. To be able to model such scenarios may be important, e.g., for machine learning.

For simulation and emulation, a radio channel is often modeled as a set of channel taps, each defined by a complex amplitude e.g. comprising attenuation and phase shift, and a delay.

The set of channel taps can be converted to a discrete impulse response. An impulse response when used herein e.g. means a set of taps for a Transmission (TX)/Reception (RX) port pair that are valid for the same time instance. The impulse response may be used to calculate the received signal by means of convolution with the transmitted signal. Alternatively, the impulse response may be converted to a frequency response, which often leads to more efficient computation of the received signal. A frequency response when used herein e.g. means a complex valued amplitude for a set of frequencies where the frequency density is inversely related to the time length for which the frequency response is valid. This conversion of the impulse response to a frequency response may be done by applying a Discrete Fourier Transform (DFT) to both the impulse response and a part of the transmitted signal, then multiplying the two together, and finally applying the Inverse Discrete Fourier Transform (IDFT).

The coefficients of the impulse response are often computed by grouping the channel taps by the coefficients they belong to and summing their amplitudes. The grouping is based on the tap delays. This means that the tap delays need to match the sampling intervals, or otherwise need to be quantized to the sampling intervals.

A fundamental problem is the computation burden when implementing radio channel emulation.

### SUMMARY

As a part of developing embodiments herein a problem was identified by the inventors and will first be discussed.

As mentioned above, a fundamental problem is the computation burden when implementing radio channel emulation. Factors that contribute to the processing complexity include the bandwidth, the number of radio transmitters and receivers, the complexity of the modeled radio channel, and the required realism. For example, a 5G NR system often employs a bandwidth of 100 MHz, requiring a sampling rate of about 108 samples per second. A meaningful digital twin may require at least a few, say 5, radio base stations, each with a least a few, say 4, radio antennas, amounting to a total of at least 20 radio transmitters in the downlink. For massive MIMO applications the number of transmitters may be much higher. The desired number of user terminals may be at least in the order of tens, say 50, with each terminal having at least two antennas. This amounts to 20×100=2000 channels. The channel complexity may be expressed in the number of taps or the length of the impulse response. In an outdoor model the impulse response might be 500 ns, corresponding to about 50 samples at 100 MHz. For a direct convolution method, this results in 1013 Complex Multiply-and-Accumulate (CMAC) operations per second for computing the received signal. In addition, the impulse response needs to be computed. Further, in future 6G systems the burden may be even higher, e.g., due to further increased bandwidths.

This amount of processing power is typically not achievable in a single standard compute node.

Another problem is to model realistic channel variations caused by moving UEs in a virtual environment. A moving UE results in time-varying tap delays. In the traditional method of computing the impulse response, each tap will stay associated with one coefficient until it moves across a sampling boundary, which will cause a jump in the impulse response.

An object of embodiments herein is to improve the performance in a wireless communications network using emulation of radio channels digital twins.

According to an aspect of embodiments herein, the object is achieved by a method performed by a network node. The method is for emulating a radio channel between a base station and a User Equipment, UE, in a wireless communications network. The network node models the radio channel as a set of channel taps. Each channel tap out of the set of channel taps is defined by a gain and a delay. The network node computes a frequency response of the radio channel directly from the set of channel taps. The frequency response is computed for a set of frequencies used by a transmitted signal in the radio channel based on the gain and the delay of the set of channel taps. The network node then emulates the radio channel by applying the computed frequency response to the transmitted signal. This is performed by multiplying the computed frequency response with a frequency domain representation of the signal transmitted on the set of a frequencies.

According to another aspect of embodiments herein, the object is achieved by a network node configured to emulate a radio channel between a base station and a User Equipment, UE, in a wireless communications network. The network node is further configured to:
model the radio channel as a set of channel taps, wherein each channel tap out of the set of channel taps, is defined by a gain and a delay,
compute a frequency response of the radio channel directly from the set of channel taps, which frequency response is adapted to be computed for a set of frequencies used by a transmitted signal in the radio channel based on the gain and the delay of the set of channel taps, and
emulate the radio channel by applying the computed frequency response to the transmitted signal by multiplying the computed frequency response with a frequency domain representation of the signal transmitted on the set of a frequencies.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a network node.

FIG. 3 is a schematic block diagram illustrating an embodiment herein.

FIG. 4 is a schematic block diagram illustrating an embodiment herein.

FIG. 5 is a schematic block diagram illustrating an embodiment herein.

FIG. 6 is a schematic block diagram illustrating an embodiment herein.

FIG. 7 is a schematic block diagram illustrating embodiments of a network node.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 12-13 are flowcharts illustrating methods implemented in a communication system including a host computer, a base station, and a user equipment.

### DETAILED DESCRIPTION

Examples of embodiments herein provide a method for efficient radio channel emulation for digital twins.

According to some examples of embodiments herein a frequency response of a signal transmitted in a radio channel is computed directly from channel taps, for a desired frequency. The frequency response is then applied to the transmitted signal by multiplying with its frequency-domain representation.

According to some further examples of embodiments herein a frequency response of transmitted signals of each respective radio channel is computed directly from the channel taps, for each desired frequency. This computation may be done independently for each frequency, potentially in parallel across compute resources. The frequency response may then be applied to the respective transmitted signal by multiplying with its frequency-domain representation.

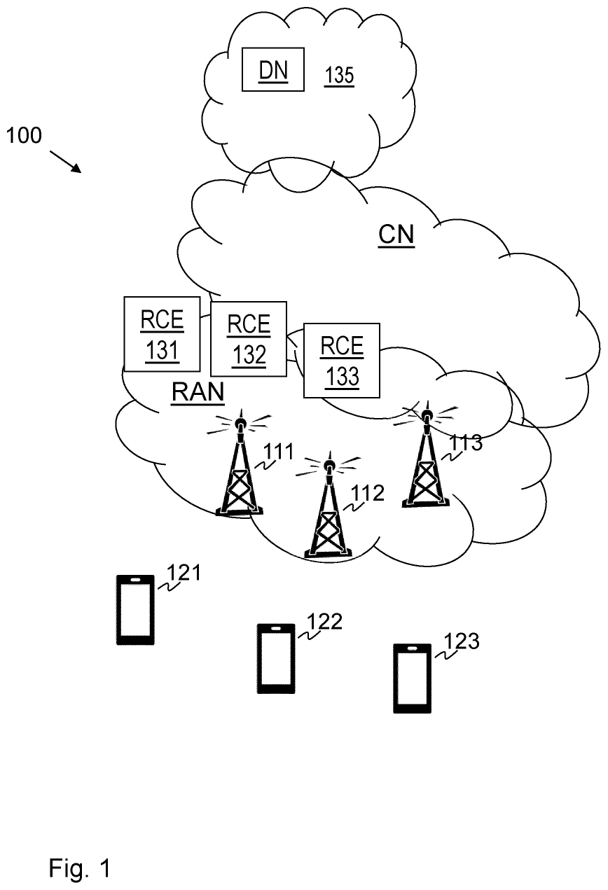

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Base stations, such as a base station 111, and one or more second base stations 112, 113 operate in the wireless communications network 100. Each respective base station 111, 112, 113, e.g. provides a number of cells and may use these cells for communicating with UEs such as e.g. a UE 121, and one or more second UEs 122, 123. The respective base station 111, 112, 113 may e.g. be a transmission and reception point e.g. a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the respective base station 111, 112, 113 depending e.g. on the radio access technology and terminology used.

UEs operate in the wireless communications network 100, such as e.g. the UE 121, and the one or more second UEs 122, 123. The respective UE 121, 122, 123, may e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Network nodes operate in the wireless communications network 100, such as e.g., a network node 131 and possibly one or more second network nodes 132, 133. The network node 131, 132, 133 may each e.g. be referred to as a Radio Channel Emulator (RCE) node 131, 132, 133. and may possibly be located in a cloud 135.

Methods herein may in one aspect be performed by the network node 131. As an alternative, a Distributed Node (DN) and functionality, e.g. comprised in the cloud 135 as shown in FIG. 1, may be used for performing or partly performing the methods of embodiments herein.

Example embodiments herein e.g., provide methods to compute and emulate the radio channel directly in the frequency domain. The method may be performed in parallel over multiple threads and/or nodes. A thread when used herein e.g. means a set of computations logically computed in sequence on e.g. a CPU core. Further, by e.g., only compute and emulate the radio channel for used frequencies, a very efficient handling of Orthogonal Frequency Division Multiplexing (OFDM) systems is possible. Further, by using the same division of frequencies for both the signal part and the interference part, an efficient calculation of the complete received signal and/or Singla to Interference Noise Ratio (SINR) is possible due to that good localization of the information is available both for signal and interference.

Advantages of embodiments herein e.g., comprise the following:

A direct calculation of the frequency response as e.g., used in the method has the benefit of better Single Instruction, Multiple Data (SIMD) and/or multi-threading performance in a single node but also a possibility to parallelize the work between multiple Graphics Processing Units (GPU)s and/or Central Processing Units (CPU)s in the same server and/or between multiple servers.

It should be noted that in modeling the radio channel both the signal and the interference may preferably be modeled in the same frequency according to prior art, thus it is much less efficient to parallelize over UEs/BSs. Due to multiantenna techniques such as beam-forming, precoding and receiver interference rejection it is not typically possible to efficiently divide antennas over multiple servers/nodes. This means that without embodiments herein, it is not possible to parallelize the work to the same extent due to this limitation.

Another benefit of embodiments herein is that by computing and emulating the radio channel directly in the frequency domain, the computations may be performed only on the subcarriers used for data transmission. Thus when there are extremely many transmissions where most are extremely small these small transmissions are very efficiently computed.

Embodiments herein enable real-time digital twin operation of larger radio networks which earlier were prohibited by the limitations of available compute power available from a single thread and/or CPU and/or GPU and/or server. Further it enables limiting channel calculations for only used frequencies. Embodiments herein may further enable more efficient operation of radio networks, machine learning and AI using digital twin operation and also cloud-based radio network testing otherwise impossible. Embodiments herein may also enable efficient distribution of data to multiple instances of radio channel emulators by only transmitting the used bandwidth to the radio channel emulators handling those frequencies.

Using a frequency domain approach allows also that any path delays may be handled, while in time-domain delays in integer values of the sample-rate are much more efficient to handle. This allows efficient and realistic modeling of time-varying scenarios, such as moving UEs.

A number of embodiments will now be described, some of which may be seen as alternatives, while some may be used in combination.

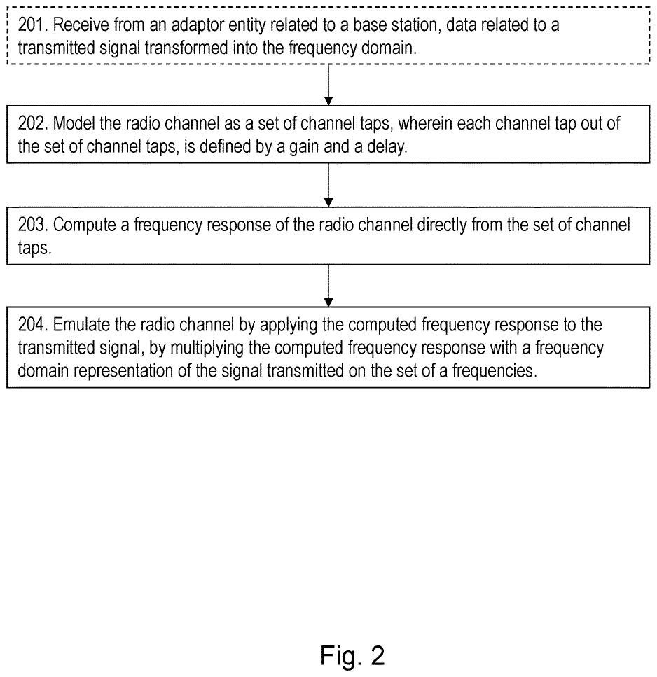

FIG. 2 shows exemplary embodiments of a method performed by the network node 131. The network node 131 may e.g. be referred to as a Radio Channel Emulator (RCE) node. The method is for emulating a radio channel between the base station 111 and the UE 121 in the wireless communications network 100. The emulating of the radio channel may e.g. be for digital twin operation.

In some embodiments, the radio channel is a combined channel. E.g. a channel comprising multiple combined channels. This is e.g. to include multiple layers in a MIMO transmission and interfering UEs. This is an advantage since in modern radio networks MIMO is used to increase throughput and interference is important to predict the performance and or suppress interference from and/or to co-scheduled UEs. The combined channel comprises a first radio channel and one or more second radio channels. The first radio channel is between the base station 111 and the UE 121. The one or more second radio channels, each are between respective one or more second base stations 112, 113 and second UEs 122, 123. E.g., such that one second radio channel is between the second base station 112, and the second UE 122, and another second radio channel is between the second base station 113, and the second UE 123.

Any one or more out of the network node 131, the base stations 111, 112, 113 and the UEs 121, 122, 123 may be virtual nodes in the cloud 135.

The method comprises the following actions, which actions may be taken in any suitable order. Optional actions are referred to as dashed boxes in FIG. 2.

### Action 201

In order to compute a frequency response later on, for a set of frequencies used by a transmitted signal in the radio channel, the signal need to be transmitted in a frequency domain. However, in some embodiments, the signal is transmitted in a time domain. In these embodiments the network node 131 may receive data from an adaptor entity related to the base station 111. The data is data related to the transmitted signal, transformed into a frequency domain, also referred to as a frequency domain split. By using the data transformed into the frequency domain, it is possible to compute a frequency response, for a set of frequencies used by the transmitted signal when transmitted in the time domain. This will be explained more in detail below.

### Action 202

The network node 131 models the radio channel as a set of channel taps. This is e.g. to capture the real environment where multiple propagation paths will result in multiple copies of a signal receiving at the receiver, attenuated, and distorted depending on the propagation conditions. Each channel tap out of the set of channel taps is defined by a gain and a delay. This may mean that each tap represents one copy of the signal.

Both the transmitted signal and interference in the channel may be modelled in the same frequency in the modelling of the radio channel. This is e.g. to capture that the two or more signals interact when receiving at the receiver after bandpass filtering the signal to only include the frequencies occupied by the signal.

### Action 203

The network node 131 computes a frequency response of the radio channel directly from the set of channel taps. Computing the frequency response of the radio channel directly from the set of channel taps means, for example, that no transformation to and from time domain is used. The frequency response is computed for a set of frequencies used by a transmitted signal in the radio channel based on the gain and the delay of the set of channel taps.

In some embodiments, the computing of the frequency response of the radio channel directly from the set of channel taps is performed directly from each respective channel tap out of the set of channel taps. This e.g., means that the channel is expressed as a sum of complex exponential terms where each term only depends on one channel tap.

In the embodiments wherein the radio channel is a combined channel, the frequency response is computed for a set of frequencies used by respective multiple transmitted signals aggregated in the combined radio channel. The computing is based on the gain and the delay of respective sets of channel taps. The multiple transmitted signals are transmitted between the base stations 111, 112, 113, and the UEs 121, 122, 123 respectively.

The set of frequencies may comprise one or more frequencies of a respective subcarrier used for data transmission. This means that each subcarrier may independently be calculated without synchronization distributed over different threads and or compute units.

In the embodiments, where the signal is transmitted in the time domain, the network node 131 has received data transformed into the frequency domain. In these embodiments the network node 131 uses the data to compute a frequency response for the set of frequencies corresponding to the time used by the transmitted signal transmitted in the time domain.

### Action 204

The network node 131 then emulates the radio channel by applying the computed frequency response to the transmitted signal. This is performed by multiplying the computed frequency response with a frequency domain representation of the signal transmitted on the set of a frequencies. This means that the signal after passing through the channel as represented on each frequency may independently be calculated without synchronization distributed over different threads and or compute units This will be described more in detail below.

In the embodiments where the radio channel is a combined channel, network node 131 applies the computed frequency response to the aggregated multiple transmitted signals by multiplying the computed frequency response with a frequency domain representation of the multiple signals transmitted on the set of a frequencies.

In this way all channel data and signals may be calculated and combined as represented on each frequency and may independently be calculated without synchronization distributed over different threads and or compute units.

Embodiments herein such as the embodiments mentioned above will now be further described and exemplified. The text below is applicable to and may be combined with any suitable embodiment described above.

In the description below, examples of implementation details, required to implement some embodiments herein, are highlighted.

### Frequency Domain Division in the Base Station 111 and/or the UE 121 Entities

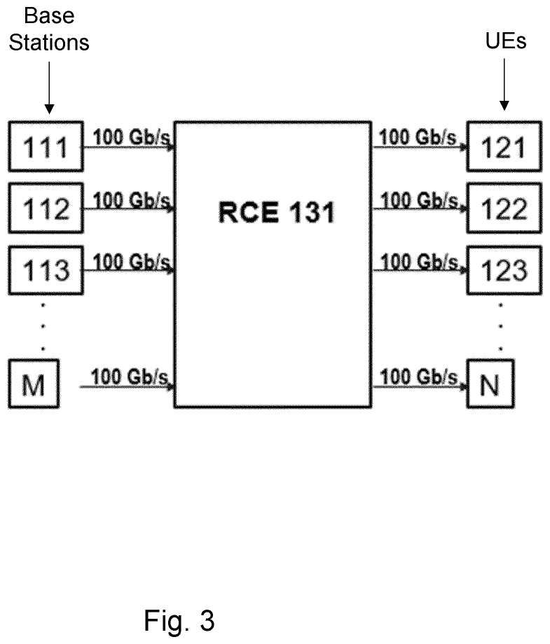

In the context of processing data for a large system of many base stations, these are also referred to as nodes herein, such as e.g. the base stations 111, 112, 113, and UEs, such as UEs 121, 122, 123, embodiments herein are very beneficial both because it is possible to split the calculations over thread and nodes, but also that the data bandwidth requirements on the interfaces to a node, such as the base station 111, scale with the bandwidth of the radio channel that said node handles. In case a single node, such as e.g., the base station 111, handles all data this node may need to aggregate all data. An example of this is depicted in FIG. 3 and illustrates a bandwidth aspect of aggregating data, here the network node 131 is referred to as RCE 131. In the example of FIG. 3 it can be seen that multiple radio data streams of each ~100 Gb/s would need to be aggregated.

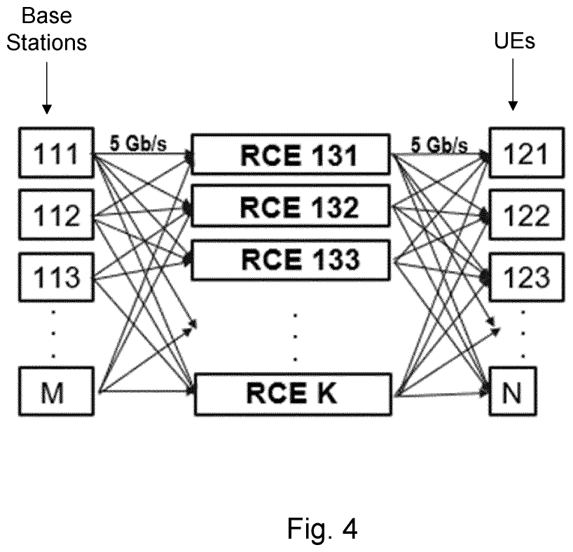

In case if an embodiment herein is implemented and a compute load is distributed over multiple RCEs 131, 132, 133 . . . M running in different threads and/or CPUs and/or GPUs and/or base stations 111, 112, 113, . . . , N, the bandwidth may also be scaled down. For example if 20 RCEs is used for the computations each RCE 131, 132, 133 . . . M would only see 1/20 of the bandwidth, i.e. ~5 Gb/s, as depicted in FIG. 4. Here the respective network node 131, 132, 133, . . . , K, is referred to as RCE 131, 132, 133, . . . , K.

FIG. 4 illustrates a bandwidth scaling when computing is distributed over multiple RCEs.

### Frequency Domain Division and Optionally Transformation in Adaptor

In some scenarios the base station 111 UE 121 implementation is not under control of the entity building the digital twin cloud implementation, such as e.g. the network node 131. In this case an adaptor entity, e.g. collocated with the respective base-station 111 and/or any of the second base stations 112, 113, may need to perform the frequency domain split of the data to distribute the compute over multiple computing network nodes such as the network node 131, and any of the second network nodes 132, 133, also referred to as RCEs.

In some scenarios the base-station 111 and/or the UE 121 are not transmitting and/or receiving frequency domain data, rather they are transmitting and/or receiving time domain data.

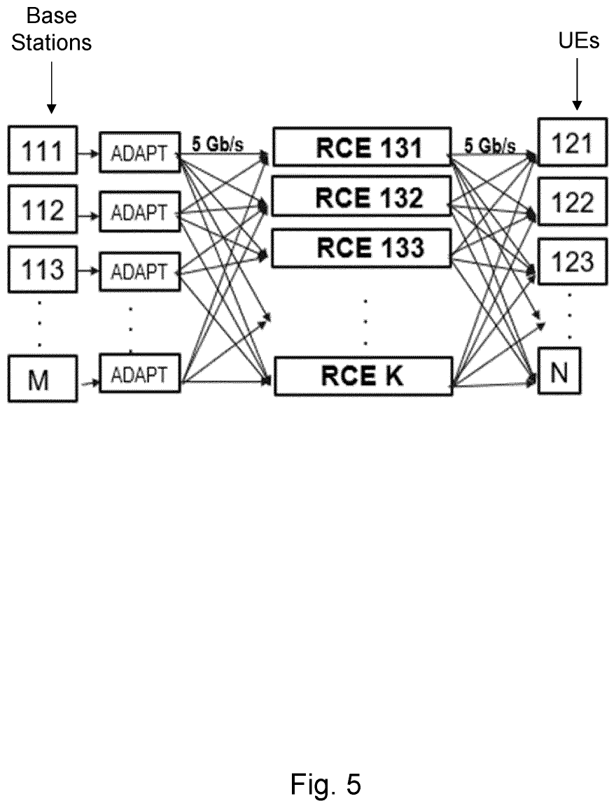

In these cases the adaptor entity will also need to transform the time domain data to frequency domain data, e.g. perform Inverse Fast Fourier Transform (FFT) and/or Inverse Fast Fourier Transform (IFFT) operations and removal and/or insertion of cyclic-prefixes etc. This is depicted in FIG. 5, where adaptor is inserted on the base station 111, 112, 113, . . . , M, side, the same may be done on the UE 121, 122, 123, . . . , N side. FIG. 5 illustrates radio channel emulator adaptors on base-station side to split data or transform time domain data to frequency domain data.

Observe that one process according to the method of embodiments herein, may map to the combined channel covering multiple radio channels also referred to as worker threads herein. The combined channel covering the multiple radio channels e.g., comprises a first radio channel between the base station 111 and the UE 121, and one or more second radio channels, each between respective one or more second base stations 112, 113 and second UEs 122, 123. This may e.g., cover multiple sub RCEs and/or GPUs and/or CPUs, and may be seen as one RCE, such as the network node 131. However, each sub RCE will see similar benefits so embodiments herein using multiple sub RCEs covered by the network node 131, should not be seen as limiting to only the case with multiple processes. This means that . . . , /Please explain what is meant.

### Frequency Calculation of Radio Channel

In some examples of the embodiments herein the radio channel is computed and emulated in the frequency domain by utilizing the relation between the delay and amplitude of the taps of the radio channel and the corresponding multiplication with the complex exponential function as may be described by the following formula. This follows from the properties of the Fourier transform or the DFT typically used:

rxⱼₘ(t)=Σtxᵢ(t−Dₙᵢⱼ)*Gₙᵢⱼ*exp(−2πj*fₘ*Dₙᵢⱼ), where
relating to the radio channel or any of the UE 121, 122, 123 or base station 111, 112, 113, j is the index of rx antenna, m is the index of the frequency, n is the tap index, i is the tx antenna index, j=√−1 (imaginary number), rxⱼₘ(t) is the received signal, txᵢ(t) is the transmitted signal, Gₙᵢⱼ and Dₙᵢⱼ is the gain and delay of a tap defined in Section 2.1. The sum is over all taps n and tx i.

### Frequency Dependent Packet Generation and Routing

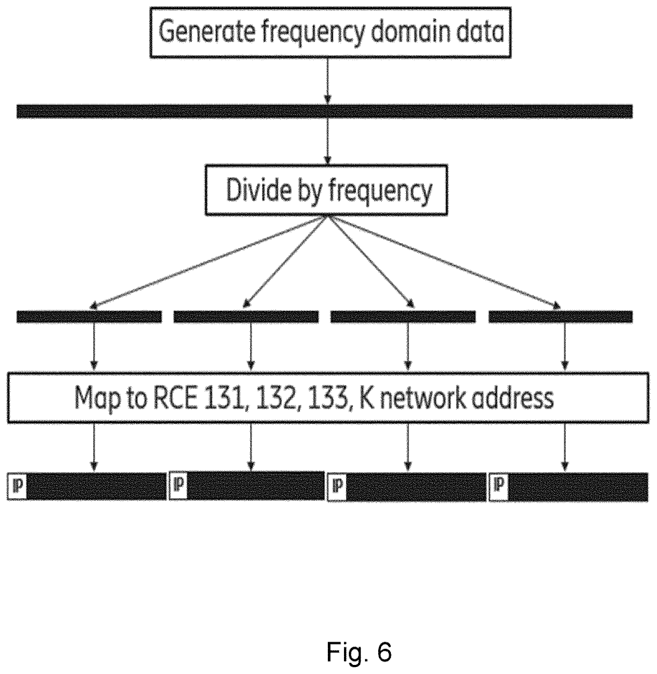

In some implementations of embodiments herein different network nodes 131, 132, 133, such as RCEs runs on different nodes in a data network. In an example implementation of embodiments herein the target address of the RCE for different frequency resources needs to be mapped correctly as depicted in FIG. 6. FIG. 6 illustrates data packet generation and network routing to IP addresses of RCEs such as the network nodes 131, 132, 133.

To perform the method actions above, the network node 131 is configured to emulate a radio channel between the base station 111 and the UE 121 in the wireless communications network 100.

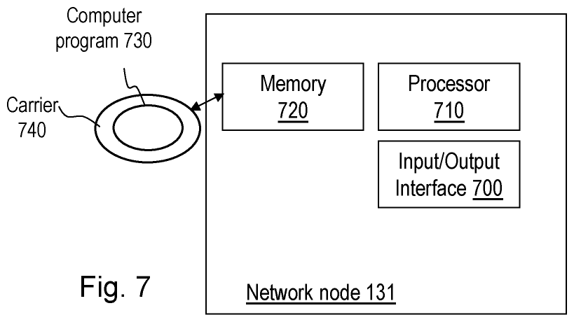

The network node 131 may comprise an arrangement depicted in FIG. 7. The network node 131 may comprise an input and output interface 700 configured to communicate in the wireless communications network 100, e.g., with the base station 111 the UE 121. The input and output interface 700 may comprise a wireless receiver not shown, and a wireless transmitter not shown.

The network node 131 is further being configured to:
model the radio channel as a set of channel taps, wherein each channel tap out of the set of channel taps, is defined by a gain and a delay,
compute a frequency response of the radio channel directly from the set of channel taps, which frequency response is adapted to be computed for a set of frequencies used by a transmitted signal in the radio channel based on the gain and the delay of the set of channel taps, and
emulate the radio channel by applying the computed frequency response to the transmitted signal by multiplying the computed frequency response with a frequency domain representation of the signal transmitted on the set of a frequencies.

In some embodiments, the radio channel is a combined channel, adapted to comprise a first radio channel between the base station 111 and the UE 121, and one or more second radio channels, each between respective one or more second base stations 112, 113 and second UEs 122, 123. In these embodiments, the network node 131 may further be configured to:
compute the frequency response for a set of frequencies used by respective multiple transmitted signals aggregated in the combined radio channel, based on the gain and the delay of respective sets of channel taps, which multiple transmitted signals are adapted to be transmitted between the base stations 111, 112, 113, and the UEs 121, 122, 123, respectively, and
apply of the computed frequency response to the aggregated multiple transmitted signals by multiplying the computed frequency response with a frequency domain representation of the multiple signals transmitted on the set of a frequencies.

The set of frequencies may be adapted to comprise one or more frequencies of a respective subcarrier used for data transmission.

In some embodiments, both the transmitted signal and interference in the channel are adapted to be modelled in the same frequency in the modelling of the radio channel.

The emulating of the radio channel may e.g. be for digital twin operation.

The network node 131 may further being configured to: compute the frequency response of the radio channel directly from the set of channel taps directly from each respective channel tap out of the set of channel taps.

In some embodiments, the signal is adapted to be transmitted in a time domain, the network node 131 may then further be configured to receive from an adaptor entity related to the base station 111, data of the transmitted signal, transformed into the frequency domain.

Any one or more out of the network node 131, the base stations 111, 112, 113 and the UEs 121, 122, 123 may be virtual nodes in the cloud 135.

The embodiments herein may be implemented through a respective processor or one or more processors, such as the processor 710 of a processing circuitry in the network node 131 depicted in FIG. 7, together with respective computer program code for performing the functions and actions of the embodiments herein. The program code mentioned above may also be provided as a computer program product, for instance in the form of a data carrier carrying computer program code for performing the embodiments herein when being loaded into the network node 131. One such carrier may be in the form of a CD ROM disc. It is however feasible with other data carriers such as a memory stick. The computer program code may furthermore be provided as pure program code on a server and downloaded to the network node 131.

The network node 131 may further comprise a memory 720 comprising one or more memory units. The memory 720 comprises instructions executable by the processor in the network node 131. The memory 720 is arranged to be used to store e.g., frequency response, information, indications, data, configurations, iterations, communication data, and applications to perform the methods herein when being executed in the frequency response.

In some embodiments, a computer program 730 comprises instructions, which when executed by the respective at least one processor 710, cause the at least one processor of frequency response to perform the actions above.

In some embodiments, a carrier 740 comprises the computer program 730, wherein the carrier 740 is one of an electronic signal, an optical signal, an electromagnetic signal, a magnetic signal, an electric signal, a radio signal, a microwave signal, or a computer-readable storage medium.

Those skilled in the art will appreciate that units in the network node 131 described above may refer to a combination of analog and digital circuits, and/or one or more processors configured with software and/or firmware, e.g. stored in the network node 131, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

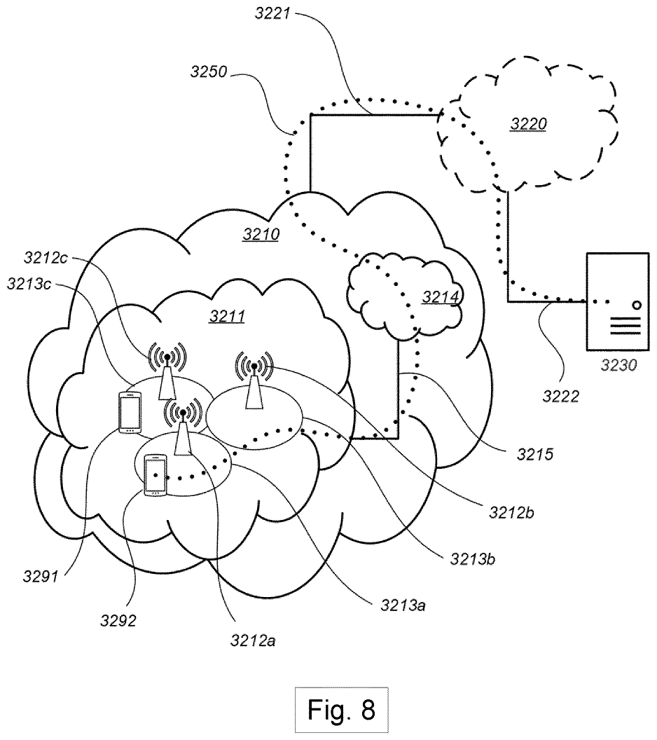

With reference to FIG. 8, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, e.g., the BS 110, such as AP STAs NBs, eNBs, gNBs or other types of wireless access points, each defining a corresponding coverage area 3213a, 3213b, 3213c. Each base station 3212a, 3212b, 3212c, e.g. radio network nodes 141,142, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

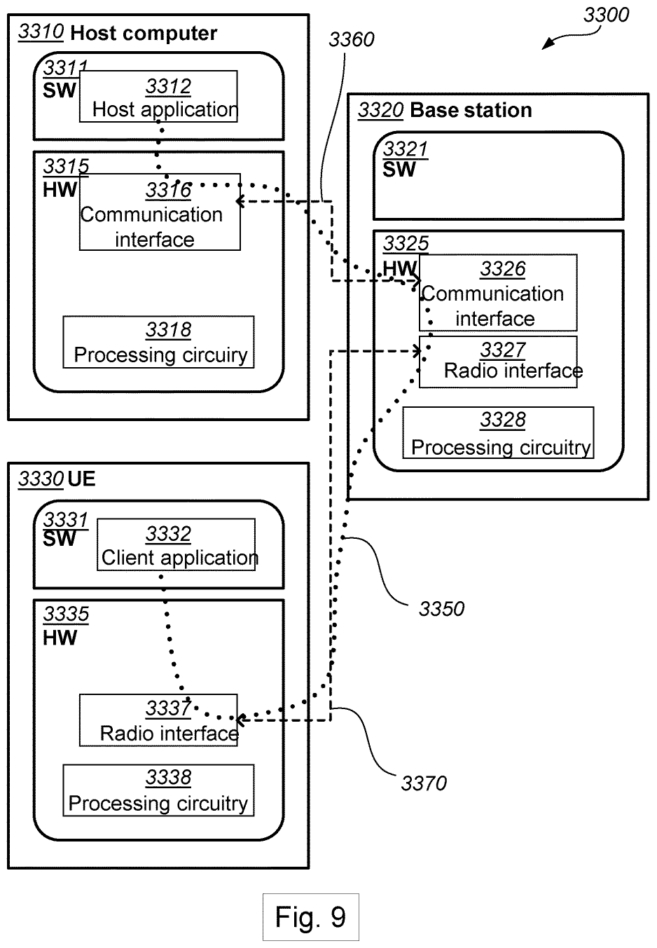

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 9, respectively. This is to say, the inner workings of these entities may be as shown in FIG. 8 and independently, the surrounding network topology may be that of FIG. 9.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc. ; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 10 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 11 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

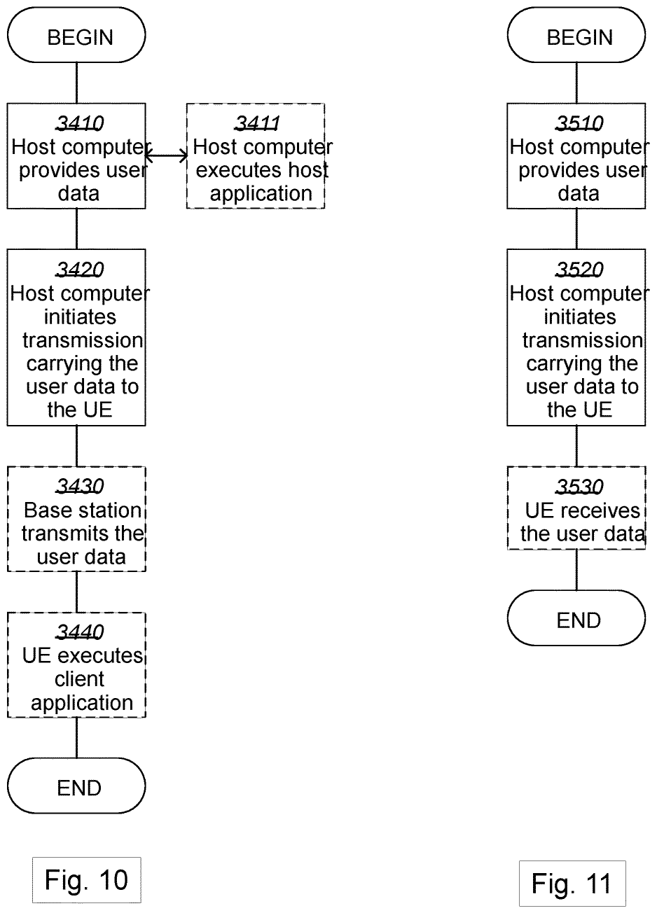

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 12 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 2610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

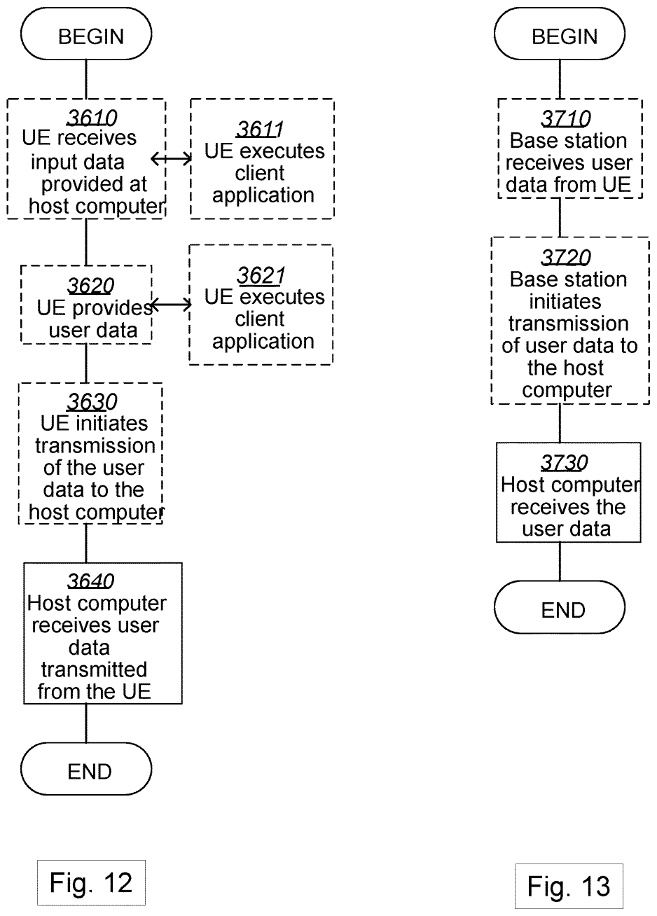

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 8 and FIG. 9. For simplicity of the present disclosure, only drawing references to FIG. 13 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1-18. (canceled)

19. A method performed by a network node for emulating a radio channel between a base station and a User Equipment (UE) in a wireless communications network, the method comprising:
modelling the radio channel as a set of channel taps, wherein each channel tap out of the set of channel taps, is defined by a gain and a delay;
computing a frequency response of the radio channel directly from the set of channel taps, which frequency response is computed for a set of frequencies used by a transmitted signal in the radio channel based on the gain and the delay of the set of channel taps; and
emulating the radio channel by applying the computed frequency response to the transmitted signal by multiplying the computed frequency response with a frequency domain representation of the signal transmitted on the set of a frequencies.

20. The method according to claim 19, wherein the radio channel is a combined channel, comprising a first radio channel between the base station and the UE, and one or more second radio channels, each between respective one or more second base stations and second UEs, and wherein
the frequency response is computed for a set of frequencies used by respective multiple transmitted signals aggregated in the combined radio channel, based on the gain and the delay of respective sets of channel taps, which multiple transmitted signals are transmitted between the base stations, and the UEs respectively, and
the applying of the computed frequency response is applied to the aggregated multiple transmitted signals by multiplying the computed frequency response with a frequency domain representation of the multiple signals transmitted on the set of a frequencies.

21. The method according to claim 19, wherein the set of frequencies comprises one or more frequencies of a respective subcarrier used for data transmission.

22. The method according to claim 19, wherein both the transmitted signal and interference in the channel are modelled in the same frequency in the modelling of the radio channel.

23. The method according to claim 19, wherein the emulating of the radio channel is for digital twin operation.

24. The method according to claim 19, wherein the computing of the frequency response of the radio channel directly from the set of channel taps is performed directly from each respective channel tap out of the set of channel taps.

25. The method according to claim 19, wherein the signal is transmitted in a time domain, the method further comprising:
receiving from an adaptor entity related to the base station, data related to the transmitted signal transformed into the frequency domain.

26. The method according to claim 19, wherein any one or more out of the network node, the base stations, and the UEs are virtual nodes in a cloud.

27. A network node configured to emulate a radio channel between a base station and a User Equipment (UE) in a wireless communications network, the network node comprising:
memory storing instructions; and
a processor operative to execute the stored instructions, whereby the processor is configured to:
model the radio channel as a set of channel taps, wherein each channel tap out of the set of channel taps, is defined by a gain and a delay;
compute a frequency response of the radio channel directly from the set of channel taps, which frequency response is computed for a set of frequencies used by a transmitted signal in the radio channel, based on the gain and the delay of the set of channel taps; and
emulate the radio channel by applying the computed frequency response to the transmitted signal by multiplying the computed frequency response with a frequency domain representation of the signal transmitted on the set of a frequencies.

28. The network node according to claim 27, wherein the radio channel is a combined channel, comprising a first radio channel between the base station and the UE, and one or more second radio channels, each between respective one or more second base stations and second UEs, and wherein the processor is configured to:
compute the frequency response for a set of frequencies used by respective multiple transmitted signals aggregated in the combined radio channel, based on the gain and the delay of respective sets of channel taps, which multiple transmitted signals are adapted to be transmitted between the base stations, and the UEs, respectively; and
apply of the computed frequency response to the aggregated multiple transmitted signals by multiplying the computed frequency response with a frequency domain representation of the multiple signals transmitted on the set of a frequencies.

29. The network node according to claim 27, wherein the set of frequencies comprises one or more frequencies of a respective subcarrier used for data transmission.

30. The network node according to claim 27, wherein both the transmitted signal and interference in the channel are modelled in the same frequency used in the modelling of the radio channel.

31. The network node according to claim 27, wherein the radio channel is emulated for digital twin operation.

32. The network node according to claim 27, wherein the processor is configured to:
compute of the frequency response of the radio channel directly from the set of channel taps directly from each respective channel tap out of the set of channel taps.

33. The network node according to claim 27, wherein the signal is transmitted in a time domain, and the processor is configured to receive from an adaptor entity related to the base station, data related to the transmitted signal, transformed into the frequency domain.

34. The network node according to claim 27, wherein any one or more out of the network node, the base stations, and the UEs are virtual nodes in a cloud.
